(19) United States
(12) Patent Application Publication
(10) Pub. No.: US 2018/0335844 A1
(43) Pub. Date: Nov. 22, 2018

(54) ELECTRONIC DEVICE, CASE FOR PORTABLE ELECTRONIC DEVICE

(71) Applicant: Nidec Copal Corporation, Tokyo (JP)

(72) Inventor: Hiroyuki HORI, Tokyo (JP)

(73) Assignee: Nidec Copal Corporation, Tokyo (JP)

(21) Appl. No.: 15/778,679

(22) PCT Filed: Nov. 22, 2016
(86) PCT No.: PCT/JP2016/084589

§ 371 Date: May 24, 2018

(30) Foreign Application Priority Data
Nov. 26, 2015 (JP) 2015-230486

(51) Int. Cl. G06F 3/01; G06F 1/16; G06F 3/041; H04B 1/3888

(52) U.S. Cl. CPC G06F 3/016; G06F 1/1601; H04B 1/3888; G06F 3/041; G06F 1/1626

(57) ABSTRACT

An operating surface of a touch inputting portion can produce good haptic feedback even without dislocation relative to a case. The electronic device comprises: a touch inputting portion; a case for supporting the touch inputting portion; a vibration actuator, disposed within the case, for applying a vibration to the operating surface of the touch inputting portion in response to a touch operation on the touch inputting portion; and an outer case unit that surrounds the outer periphery of the case, wherein: the outer case unit comprises a hard layer, at the outermost layer, and an elastic layer, on the inside of the hard layer, for holding the case so as to enable movement in the direction that is perpendicular to the operating surface.

### CROSS-REFERENCE TO RELATED APPLICATIONS

This is a U.S. national phase application under 35 U.S.C. § 371 of International Patent Application No. PCT/JP2016/084589, filed Nov. 22, 2016, and claims benefit of priority to Japanese Patent Application No. 2015-230486, filed Nov. 26, 2015. The entire contents of these applications are hereby incorporated by reference.

### FIELD OF TECHNOLOGY

The present invention relates to an electronic device equipped with a touch inputting portion, and to a case for a mobile electronic device.

### BACKGROUND

In electronic devices, in recent years those that are equipped with touch panels or touch pads as touch inputting portions, such as smart phones and mobile telephones, tablet terminals, PDAs (Personal Digital Assistants), mobile PCs, and the like, have become popular. Here “electronic device” includes mobile electronic devices and wearable electronic devices that are carried or worn on a portion of the user body.

The touch inputting portion is an interface that detects a touch by the operator on an operating surface, such as the front panel, to produce an input signal, and a variety of different operating principles are known, such as an electrostatic capacitance type, a resistance film type, an infrared radiation type, an electromagnetic induction type, or the like. Typically, the touch inputting portion cooperates with a displaying portion to enable the operator to identify visually that a signal has been inputted, but one difficulty is that it has not been possible to produce haptic feedback reliably, such as there is with the operation of a button on the keyboard.

In relation to this, in recent years there has been research into skin tactile feedback technology (haptic technology) that provides a force, vibration, movement, or the like, to the operator of the interface, and there have been proposals for feedback of vibration to, for example, the finger of the user who has performed an operation in touch inputting portions as well. At this time, simply vibrating the operating surface may cause discomfort to the operator, a feeling as if there has been an electrostatic shock, and thus skin tactile feedback that can provide a more comfortable feeling of operation is desirable.

The prior art described in Japanese Unexamined Patent Application Publication 2012-174103, below, describes an electronic device that generates a vibration on the operating surface of a touch panel when the touch panel detects contact by the operator, wherein the touch panel is supported elastically in the thickness direction, to produce good haptic feedback through causing a large vibration in the touch panel.

### SUMMARY

Because the touch inputting panel (for example, a touch panel) is supported elastically within the case of the electronic device, such as in the prior art, when the operating surface of the touch inputting portion is pressed with a finger, or the like, the operating surface undergoes dislocation in the direction that is perpendicular to the operating surface (the z direction). Through this, the operator is able to obtain it good haptic feedback. However, when the touch inputting portion is supported elastically in relation to the case of the electronic device, the support structure for reliably ensuring dust-proofing and water-proofing becomes complex, and there is a problem in that this inevitably increases costs. Given this, there is the need for skin tactile feedback to produce good haptic feedback without a large dislocation, in the z direction, of the operating surface of the touch inputting portion relative to the case of the electronic device.

In order to solve such a problem, the present invention is provided with the following structures:

An electronic device comprising: a touch inputting portion; a case for supporting the touch inputting portion; a vibration actuator, disposed within the case, for applying a vibration to an operating surface of the touch inputting portion in response to a touch operation on the touch inputting portion; and an outer case unit that encloses the outer periphery of the case, wherein: the outer case unit comprises a hard layer as the outermost layer, and an elastic layer, on the inside of the hard layer, for holding the case so as to enable movement in a direction that is perpendicular to the operating surface.

### BRIEF DESCRIPTIONS OF THE DRAWINGS

FIG. 1 is an explanatory diagram illustrating an electronic device according to an embodiment according to the present invention.

FIG. 2 is an explanatory diagram illustrating an example of a vibration actuator (a linear vibration motor) which is provided in an electronic device according to an embodiment according to the present invention.

FIG. 3(a) is an explanatory diagram illustrating the state wherein there is a touch operation, by a finger, on the operating surface of an electronic device according to an embodiment according to the present invention showing a state wherein the electronic device is held in one hand.

FIG. 3(b) is an explanatory diagram illustrating the state wherein there is a touch operation, by a finger, on the operating surface of an electronic device according to an embodiment according to the present invention showing a state wherein the operating surface is subjected to a touch operation using a finger of the other hand.

FIG. 4(a) is an explanatory diagram illustrating a case wherein an electronic device is installed (a mobile electronic device case illustrating a perspective diagram.

FIG. 4(b) is an explanatory diagram illustrating a case wherein an electronic device is installed (a mobile electronic device case) illustrating a cross-sectional view.

### DETAILED DESCRIPTION

Examples according to the present invention will be explained below in reference to the drawings. Note that in the explanation below, identical reference symbols in the various drawings indicate identical positions, and some redundant explanations are omitted. While the explanation below uses a mobile electronic device as an example of an electronic device, the electronic device in embodiments of the present invention is not limited in particular it thereto.

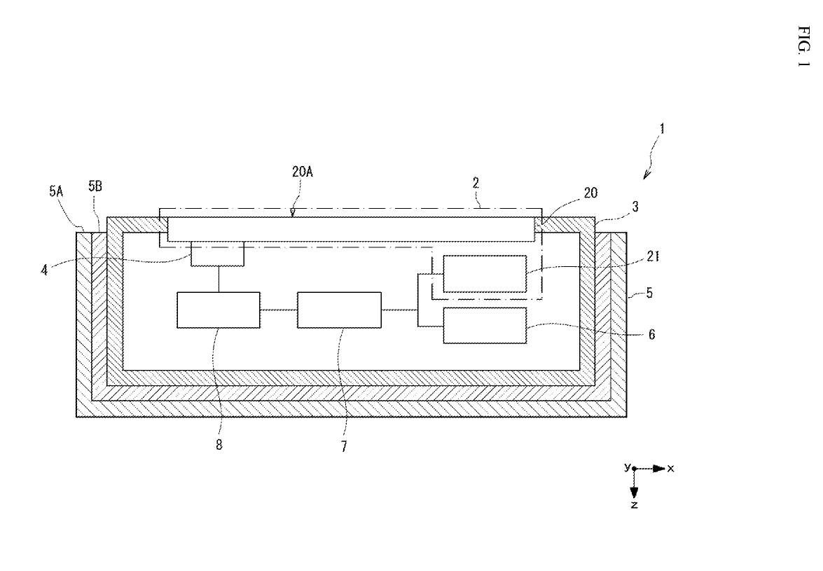

As illustrated in FIG. 1, the mobile electronic device 1 that is an example of an electronic device according to an embodiment according to the present invention comprises: a touch inputting portion 2, a case 3, a vibration actuator 4, and an outer case unit 5. The touch inputting portion 2 comprises a front panel 20, with the surface thereof serving as an operating surface 20A, comprising touch sensors 21, and the like, that detect touch operations on the operating surface 20A, and comprises touch sensors, and the like, for detecting touch operations on the operating surface 20A in response to any of a variety of operating methods. The touch inputting portion 2 (or front panel 20) is supported fixedly, without dislocating relative to the case 3. In the diagrams below, the x and y directions indicate two different directions along the operating surface 20A, and the z direction indicates a direction that is perpendicular to the operating surface 20A.

The vibration actuator 4 is equipped within the case 3, and is that which applies a vibration to the operating surface 20A in response to a touch operation on the touch inputting portion 2. The vibration actuator 4 is driven through a vibration generating signal that is outputted by a vibration generating portion 8, where the controlling portion 7 drives the vibration generating portion 8 depending on the output of a pressure sensor 6 or the touch sensor 21, described above, that detects pressure on the operating surface 20A. The pressure sensor 6 or touch sensor 21, the controlling portion 7, and the vibration generating portion 8 are disposed within the case 3.

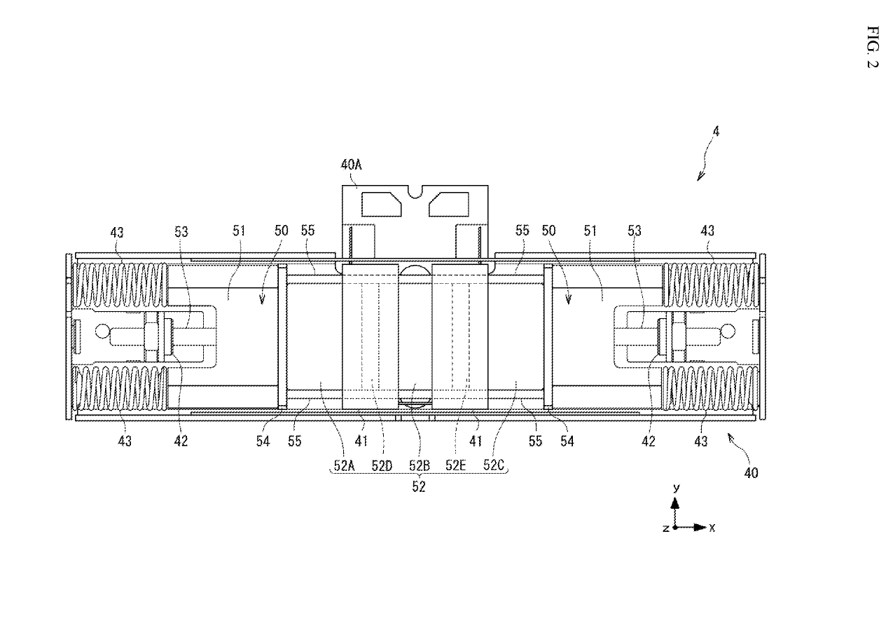

The vibration actuator 4 preferably applies, to the operating surface 20A, a vibration along the operating surface 20A, and, as an example, is installed on the inner side of the front panel 20 that has the operating surface 20A. As an example of the vibration actuator 4, a linear vibration motor that produces a crosswise vibration may be employed, as shown in FIG. 2.

Note that while a linear vibration motor, as described below, that produces a crosswise vibration along the operating surface 20A is well-suited for the vibration actuator 4, there is no limitation thereto. It may instead be a rotary vibration motor wherein an eccentric weight is secured to a rotary shaft, or a linear vibration motor that produces a longitudinal vibration in the z direction that is perpendicular to the operating surface 20A. Moreover, while installation on the inside of the front panel 20 that has the operating surface 20A is suitable for the vibration actuator 4, there is no limitation thereto, and it may instead be installed on the case 3.

An example of a vibration actuator 4 is shown in FIG. 2, where, in this vibration actuator 4, the movable element 50 is borne, on the inside of a frame 40 that serves as the stationary element, so as to enable vibration along the axial direction thereof (the x direction in the figure). The movable element 50 comprises a magnet portion 52 that is disposed between a pair of weight portions 51, where a guide shaft 53 that extends in the direction of vibration is secured to the weight portions 51. The magnet portion 52 comprises magnet pieces 52A, 52B, and 52C that are magnetized along the direction of vibration, and are disposed so that identical poles facing each other, with spacers 52D and 52E disposed between the magnet pieces 52A, 52B, and 52C. The weight portion 51 and the magnet portion 52 are combined together into a single unit by the connecting member 54 and a reinforcing member 55.

A coil 41 is secured to the frame 40 that serves as the stationary element. The coil 41 is wrapped around the vibration direction (the x direction in the figure), and the movable element 50 is disposed so as to enable sliding within the coil 41. In the example in the figure, a pair of coils 41, which are connected in series, are disposed with opposing coiling directions, where the respective coils 41 are disposed on the peripheries of the spacers 52D and 52E, respectively. Moreover, a bearing 42, for bearing the guide shaft 53 of the movable element 50, is attached to the frame 40, and a plurality of elastic members 43 are disposed between the movable element 50 (the weight portions 51) and the frame 40.

In this way, the vibration actuator 4 produces a linear vibration along the axial direction thereof (a crosswise vibration) through the effect of Lorentz forces (driving forces) along the axial direction of the magnet portion 52 (the x direction in the figure) through the inputting of a vibration generating signal (for example, an alternating current with a resonant frequency that is determined by the mass of the movable element 50 and the coefficient of elasticity of the elastic members 43) into the coil 41 through an input terminal 40A that is provided on the frame 40.

The mobile electronic device 1 comprises an outer case unit 5 that encloses the outer periphery of the case 3. The outer case unit 5 comprises a hard layer 5A as the outermost layer, as illustrated in FIG. 1, where an elastic layer 5B that holds the case 3 so as to enable movement in the direction that is perpendicular to the operating surface 20A is provided on the inside of the hard layer 5A. In the example in the figure, the outer case unit 5 has a two-layer structure, of the hard layer 5A and the elastic layer 5B, but there is no limitation thereto, and it may instead be a multilayer structure of three or more layers through providing another layer between the hard layer 5A and the elastic layer 5B, or another layer over the elastic layer 5B.

The operation of such a mobile electronic device 1 will be explained. When there is a touch operation on the operating surface 20A in the touch inputting portion 2 of the mobile electronic device 1, the touch inputting portion 2 outputs, to the controlling portion 7, an input signal in response to the output of the touch sensor 21. Moreover, when there is a touch operation on the operating surface 20A, the controlling portion 7 drives the vibration generating portion 8 depending on the output of the touch sensor 21 or of the pressure sensor 6, and the vibration actuator 4 is driven by the vibration generating signal that is outputted from the vibration generating portion 8. Through this, a vibration is applied to the operating surface 20A in the x or y direction. On the other hand, in the mobile electronic device 1, wherein the touch inputting portion 2 is supported in the case 3, the case 3 is held in the outer case unit 5 that has the elastic layer 5B, and thus when there is a touch operation on the operating surface 20A, the elastic layer 5B deforms under the finger pressure, and the case 3 is pressed in, in relation to the outer case unit 5, so that the operating surface 20A is dislocated in the z direction.

The mobile electronic device 1 according to the example according to the present invention, through the touch operation on the operating surface 20A, takes advantage of the characteristics of the skin sensory receptor corpuscle, to provide comfortable haptic feedback that is similar to the feeling of a click, through tricking the brain by applying a vibration to the operating surface 20A in the x or y direction (the direction along the operating surface 20A) simultaneously with the operating surface 20A dislocating in the z direction (the direction that is perpendicular to the operating surface 20A). At this time, the dislocation of the operating surface 20A need not necessarily be a dislocation of the operating surface 20A alone, but rather a comfortable haptic feedback can also be obtained through the same trick even when the dislocation of the operating surface 20A is through the case 3, which supports the operating surface 20A, being pressed in.

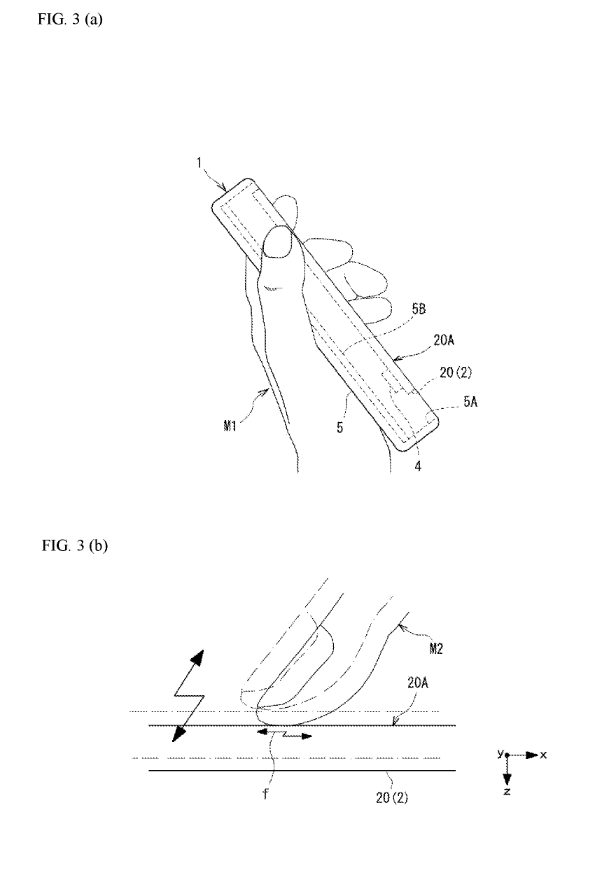

The operator holds the mobile electronic device 1 in one hand Ml, as illustrated in FIG. 3(a), and performs the touch operation on the operating surface 20A using a finger M2 of the other hand, as illustrated in FIG. 3(b). When there is a touch operation, using a finger, on the operating surface 20A, the operating surface 20A undergoes dislocation in the z direction, and if, simultaneously therewith, a vibration (a crosswise vibration) fin the x or y direction is applied to the operating surface 20A, the tactile sensory receptor corpuscle, known as the Meissner tactile corpuscle, which exists near the surface of the skin of the finger M2, will receive a sensation that is similar to a shift in the skin surface, and the tactile sensory receptor corpuscles that are known as Pacinian corpuscles, which exist in the tissue under the skin of the finger M2, will receive a sensation that is similar to that of pressing in with the finger. When these sensations are transmitted to the brain, the brain triggers the same illusion as if the operating surface 20A were partially pressed in, producing comfortable haptic feedback that feels like a click.

In order to produce this illusion reliably, there is the need for the dislocation of the operating surface 20A in the z direction, and the vibration fin the x or y direction of the operating surface 20A, to not propagate to the one hand M1 on the side that holds the mobile electronic device 1. In order to satisfy this need, the hard layer 5A is provided in the outermost layer, in the outer case unit 5 of the mobile electronic device 1. Additionally, the elastic layer 5B of the outer case unit 5 functions so as to enable dislocation of the operating surface 20A in the z direction, with the case 3 being pressed in, relative to the outer case unit 5, through the touch operation on the operating surface 20A, and also absorbing the vibration f that acts on the operating surface 20A through driving of the vibration actuator 4, so as to produce a function that reduces the propagation of the vibration f to the hard layer 5A. In order to have this function, a raw material that has flexibility and elasticity is preferred for the elastic layer 5B, which may be formed from, for example, a polyurethane layer, or the like. This outer case unit 5 may be adhered integrally, through an adhesive, or the like, to the case 3, or may be installed removably.

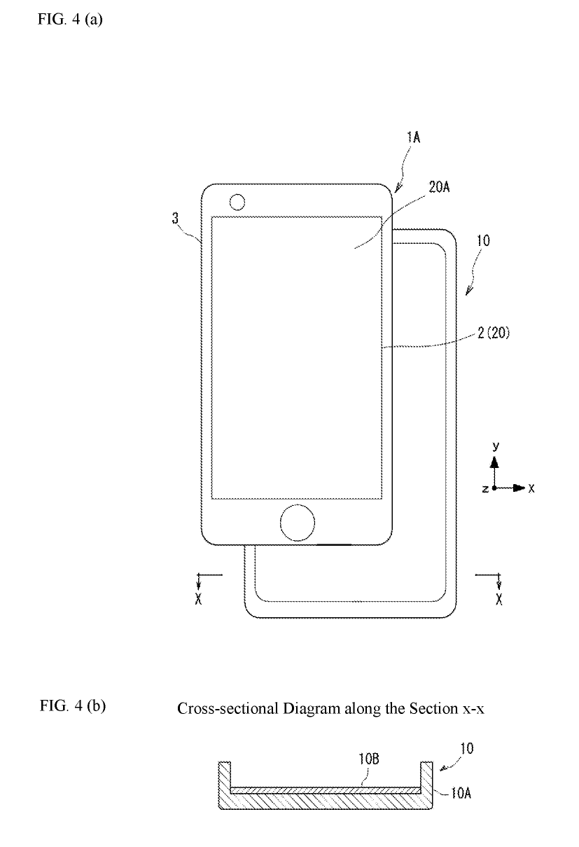

FIG. 4 shows an example wherein a case (a mobile electronic device case) 10 is installed removably for a mobile electronic device 1A is not provided with the outer case unit 5 described above. FIG. 4(a) shows the state wherein the case 10 is removed from the mobile electronic device 1A. Here the case 10 has the same functions as the outer case unit 5, described above. That is, the case 10, as depicted in FIG. 4(b), comprises a hard layer 10A as the outermost layer, and an elastic layer 10B, on the inside of the hard layer 10A, to hold the case 3 of the mobile electronic device 1A so as to enable movement in the z direction. At this time, in the mobile electronic device 1A, the touch inputting portion 2 should be supported in the case 3, and should have a function that applies a vibration to the operating surface 20A of the touch inputting portion 2 in response to a touch operation on the touch inputting portion 2. Installing a mobile electronic device 1A that has such a function is installed in the case 10 enables a touch operation input that produces comfortable haptic feedback through the trick as described above.

The mobile electronic device 1 according to the embodiment according to the present invention, or the mobile electronic device 1A wherein the case 10 is equipped, enables the touch inputting portion 2 (or the front panel 20) to be fixedly supported, without dislocation relative to the case 3. This enables production of a mobile electronic device 1 or 1A with excellent dust-proofing and water-proofing performance without the use of a complex support structure. Additionally, merely providing the outer case unit 5 or case 10, which has no effect on the internal structure of the mobile electronic device 1 or 1A, enables achievement of a touch operation input that has comfortable haptic feedback through tricking the brain.

While embodiments according to the present invention were described in detail above, referencing the drawings, the specific structures thereof are not limited to these embodiments, but rather design variations within a range that does not deviate from the spirit and intent of the present invention are also included in the present invention. Moreover, insofar as there are no particular contradictions or problems in purposes or structures, or the like, the technologies of the various embodiments described above may be used together in combination.

1. An electronic device comprising:
a touch input;
a case for supporting the touch input;
a vibration actuator, disposed within the case, applying a vibration to an operating surface of the touch input in response to a touch operation on the touch input; and
an outer case unit that encloses an outer periphery of the case, wherein:
the outer case unit comprises a hard layer as an outermost layer, and an elastic layer, on an inside of the hard layer, holding the case to enable movement in a direction that is perpendicular to the operating surface.

2. The electronic device as set forth in claim 1, wherein:
the vibration actuator is a linear vibration motor that produces a crosswise vibration along the operating surface.

3. The electronic device as set forth in claim 1, wherein:
the vibration actuator is equipped on an inside of a front panel that has the operating surface.

4. The electronic device as set forth in claim 1, wherein:
the outer case unit is installed removably relative to the case.

5. A mobile electronic device case that is installed removably on a mobile electronic device wherein a touch input is supported on a case, and applies a vibration to an operating surface of the touch input in response to a touch operation on the touch input, comprising:
a hard layer at the outermost layer, and an elastic layer, on the inside of the hard layer, holding the case to enable movement in the direction that is perpendicular to the operating surface.
